(19) United States
(12) Patent Application Publication
(10) Pub. No.: US 2025/0378669 A1
(43) Pub. Date: Dec. 11, 2025

(54) METHODS AND SYSTEMS FOR UNIT CELL CREATION AND VISUALIZATION

(71) Applicant: CARBON, INC., Redwood City, CA (US)

(72) Inventors: Andrew SINK, Charlotte, NC (US); Austin M. MERLO, Gallatin, TN (US)

(21) Appl. No.: 19/225,587

(22) Filed: Jun. 2, 2025

Related U.S. Application Data
(60) Provisional application No. 63/656,146, filed on Jun. 5, 2024.

(51) Int. Cl. G06T 19/20; G06F 9/451; G06T 15/00

(52) U.S. Cl. CPC G06T 19/20; G06T 15/00; G06F 9/451; G06T 2200/24; G06T 2219/2021

(57) ABSTRACT

A method for designing a unit cell may include receiving input data via a user interface, the input data including one or more input design parameters for a unit cell, rendering a virtual three-dimensional (3D) representation of the unit cell within the user interface, based on the input design parameters, receiving, via the user interface, at least one modification command modifying the virtual 3D representation of the unit cell, altering the input data based on the received modification command, resulting in modified design parameters for the unit cell differing from the input design parameters, and outputting the modified design parameters for the unit cell.

### RELATED APPLICATIONS

This application claims priority from U.S. Provisional Application No. 63/656,146, filed Jun. 5, 2024, the disclosure of which is incorporated by reference in its entirety.

### BACKGROUND OF THE INVENTION

The present disclosure relates to methods and systems for unit cell creation and visualization, and more particularly, to methods and systems for unit cell creation and visualization in the field of additive manufacturing.

A lattice may refer to a structure having a regular, repeating three-dimensional arrangement of unit cells. The lattice may be a geometric structure, and the unit cells may be repeating geometric patterns that define the overall geometric structure of the lattice. In some applications, such as additive manufacturing (e.g., three-dimensional (3D) printing) applications, each unit cell may include interconnected struts or beams that are arranged in a specific configuration. The unit cell may then be replicated and copies of the unit cell may be combined to create the final lattice structure. Unit cells, and the arrangement of the interconnected struts and beams of the unit cells, may determine, for example, the mechanical properties (e.g., stiffness, strength, weight, etc.), the density and porosity, the aesthetics, the material usage, the manufacturability, and the like of the lattice structure, and thus, the properties of the resultant object manufactured through additive manufacturing.

### SUMMARY OF THE INVENTION

According to some aspects of the present disclosure, a method for designing a unit cell may include receiving input data via a user interface, the input data including one or more input design parameters for a unit cell, rendering a virtual three-dimensional (3D) representation of the unit cell within the user interface, based on the input design parameters, receiving, via the user interface, at least one modification command modifying the virtual 3D representation of the unit cell, altering the input data based on the received modification command, resulting in modified design parameters for the unit cell differing from the input design parameters, and outputting the modified design parameters for the unit cell.

According to some aspects of the present disclosure, a system for designing a unit cell may include at least one processor, and memory storing non-transitory computer-readable instructions that, when executed by the at least one processor, cause the at least one processor to perform operations including: receive, as a first input via a user interface, input data including one or more input design parameters for a unit cell, render, based on the input data, a virtual three-dimensional (3D) representation of the unit cell, receive, as a second input via the user interface, a modification command indicating a requested modification to the virtual 3D representation of the unit cell, alter, based on the received modification command and the requested modification, the input design parameters for the unit cell, resulting in modified design parameters, and output the modified design parameters for the unit cell.

According to some aspects of the present disclosure, a method for designing a unit cell may include receiving input data via a user interface, the input data including one or more design parameters for a unit cell, rendering, within the user interface, a virtual three-dimensional (3D) representation of the unit cell, and outputting design specifications for the unit cell.

Aspects of the present disclosure are not limited to the above. Further aspects of the present disclosure will be understood by one of ordinary skill in the art based on the description hereinafter.

### BRIEF DESCRIPTION OF THE DRAWINGS

The accompanying drawings, which are incorporated in and constitute a part of the specification, illustrate example embodiments of the present disclosure and, together with the description, serve to explain principles of the present disclosure.

FIG. 1 is an example diagram illustrating a conventional method for visualization of a unit cell, according to some embodiments of the present disclosure.

FIG. 2 is an example diagram illustrating a method for visualization of a unit cell, according to some embodiments of the present disclosure.

FIG. 3 is an example diagram illustrating a system for creation and visualization of a unit cell, according to some embodiments of the present disclosure.

FIG. 4 is an example diagram illustrating a custom unit cell, according to some embodiments of the present disclosure.

FIGS. 5A and 5B are example diagrams illustrating a custom unit cell and a lattice including the custom unit cell, respectively, according to some embodiments of the present disclosure.

FIGS. 6A and 6B are example diagrams illustrating a custom unit cell and a lattice including the custom unit cell, respectively, according to some embodiments of the present disclosure.

FIGS. 7A and 7B are example diagrams of a custom unit cell and a lattice including the custom unit cell, according to some embodiments of the present disclosure.

FIG. 8 is an example flowchart illustrating a method for designing a unit cell, according to some embodiments of the present disclosure.

FIGS. 9A and 9B are example diagrams of two-dimensional unit cells, according to some embodiments of the present disclosure

FIGS. 10A and 10B are example diagrams for illustrating a triangle mesh and a lattice for a saddle generated using the triangle mesh, according to some embodiments of the present disclosure.

FIGS. 11A and 11B are example diagrams for illustrating a triangle mesh and a lattice for a footwear upper generated using the triangle mesh, according to some embodiments of the present disclosure.

### DETAILED DESCRIPTION

As discussed above, a unit cell may include a plurality of interconnected struts or beams, with each strut or beam between two nodes. The nodes may be located within the unit cell and may serve as connection points where the structural elements of a lattice intersect and form the overall geometry of the unit cell. For example, the nodes may be located where struts intersect. The nodes may help define the overall shape, strength, and connectivity of a lattice structure resulting from the unit cell, which may influence the physical properties of a 3D printed object such as, for example, stiffness, strength, weight, etc.

Although systems for designing a lattice structure from unit cells exist, conventional systems have various disadvantages. In particular, conventional systems tend to be inflexible and often start with the assumption that the unit cell already exists. That is, conventional systems generally do not allow for customization of the unit cell, nor do they allow for the unit cell to be built from scratch. Instead, users of conventional systems may be presented with a limited number of unit cells (e.g., a library of unit cells) to work with that each have a predetermined structure. As such, users may be constrained to design 3D printed objects within the predetermined structure of each unit cell, which may significantly limit the customization potential of the 3D printed object and may stifle the creativity of the user. Moreover, conventional systems may be ill-equipped for tailoring 3D printed objects to specific applications, as they are bound by the predetermined and fixed structure of each unit cell.

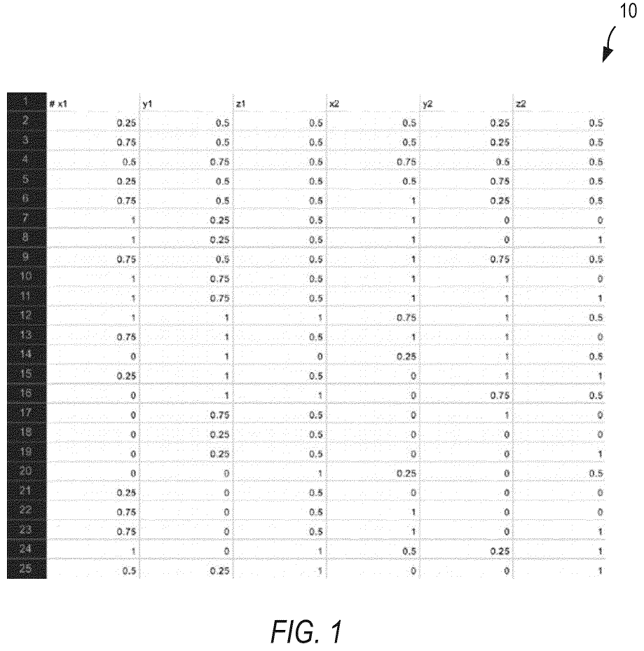

Conventional systems may also suffer from disadvantages related to the visualization of the unit cell. FIG. 1 is an example diagram illustrating a conventional method for visualization of a unit cell, according to some embodiments of the present disclosure. Referring to FIG. 1, the unit cell may be depicted as a series of coordinates 10 that define its structural composition. The presentation of such coordinates may make it difficult for a user to visualize the unit cell since it is represented as nodes having coordinates in a three-dimensional space (e.g., X, Y, and Z coordinates) and as connections between two nodes (e.g., struts). As such, this visualization method may act as a barrier to entry, especially for novice and less-experienced users.

Example embodiments of the present disclosure provide various benefits and technical solutions to the foregoing and/or other problems associated with conventional systems. For example, some embodiments of the present disclosure may provide methods and systems for customization and/or creation of unit cells from scratch or the ground up. In addition, some embodiments of the present disclosure may provide methods and systems for real-time visualization of the unit cell within a user interface, thereby allowing a user to monitor more easily the impact of design modifications to the unit cell. Accordingly, example embodiments of the present disclosure may facilitate more rapid prototyping of a lattice structure and the freedom to create custom designs thereof for a variety of applications, thereby providing increases to the speed of designing and manufacturing objects using additive manufacturing.

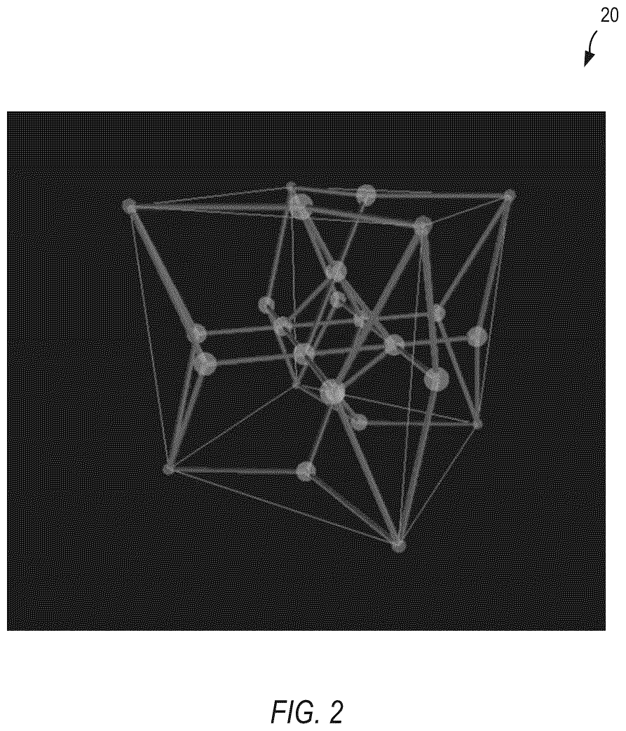

FIG. 2 is an example diagram illustrating a method for visualization of a unit cell, according to some embodiments of the present disclosure.

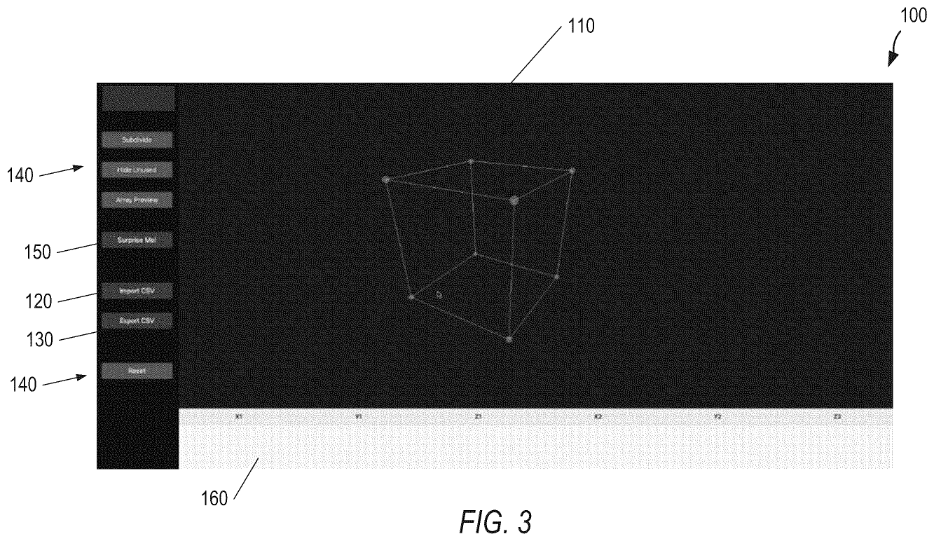

Referring to FIG. 2, the unit cell may be displayed in a user interface (an example of which is shown in FIG. 3). The user interface may provide a virtual three-dimensional representation 20 of the unit cell, thereby allowing a user to see the unit cell in a visual format and observe how design modifications to the unit cell affect its geometry and other properties.

FIG. 3 is an example diagram illustrating a system for creation and visualization of a unit cell, according to some embodiments of the present disclosure.

Referring to FIG. 3, the system may provide a user interface 100 that allows a user to visualize unit cells in three-dimensions and in real-time, and dynamically adjust their design parameters. For example, a user may interactively modify the geometry of a unit cell (e.g., placement or location of nodes and struts), along with other properties of the unit cell, while observing the effect of the modifications through a virtual three-dimensional representation of the unit cell.

For example, a user may create the unit cell from scratch, beginning with placing nodes within the user interface portion 110 and by drawing (e.g., using an input mechanism, such as a pointing device or touch input) struts between nodes placed in the user interface portion 110. The user may be able to provide modification commands to, e.g., rotate, zoom, shift, move and/or delete the nodes and struts within the user interface portion 110. For example, the user may be able to select one or more nodes and move them to different points within the user interface portion 110. As another example, the user may be able to select one or more struts and move them to different points within the user interface portion 110. In response to receiving one or more of the modification commands, the system may modify data (e.g., array data, tabular data, matrix data) corresponding to the unit cell visualized in the user interface portion 110.

In some embodiments, the user may be able to select an import command 120, and thereby select and import a file (e.g., a file containing comma separated values) that includes coordinates corresponding to an existing unit cell design. The user may then customize the existing design by using one or more modification commands. The system may thus allow users to develop a lattice structure from the unit cell that is tailored to the user's needs, thereby facilitating increased flexibility in the design and fabrication of 3D printed objects. Further, by allowing the user to have the freedom to design and customize the unit cell, the system may facilitate improved structural integrity and/or performance of the 3D printed objects.

The user may be able to select an export command 130, and thereby export (e.g., to a file) data corresponding to the unit cell currently visualized in the user interface portion 110. The exported data may be provided to a lattice-generation software (e.g., Carbon Design Engine™) and generate machine-readable instructions for 3D printing the lattice structure.

In some embodiments, a user can modify design parameters of the unit cell through a graphical user interface (GUI). The GUI may provide tools (e.g., modification commands) that allow the user to customize, for example, the geometry, dimensions, material properties and the like of the unit cell. As the user makes modifications to the properties of the unit cell, the system may update a virtual 3D representation of the unit cell in real-time, thereby providing instant feedback to the user. The user may thus be able to observe in real-time how design modifications to the unit cell impact its appearance and structural characteristics. The real-time visualization of the unit cell may enhance the user's understanding of the unit cell and enable the user to make informed decision-making when modifying the design of the unit cell.

In some embodiments, the system may provide additional commands, such as commands 140 that allow a user to subdivide a unit cell, hide unused elements of the unit cell (e.g., line segments, struts, etc.), array preview the unit cell, and/or reset a unit cell design (e.g., remove all struts and/or nodes from the user interface portion 110). For example, these features may be provided through the GUI. In some embodiments, the system may provide a formatting table 160 for numerical data related to the unit cell (e.g., X, Y, and Z coordinates of the unit cell).

In some embodiments, the system may include a random generator command 150 (which may also be referred to as a ‘Surprise Me!’ command) that generates a random or semi-random unit cell. The random generator command 150 may include an option for a user to add rules to a generated unit cell such as, for example, the number of connections (e.g., the number of nodes), the number of line segments (e.g., the number struts), and the like, which can enable a user to control the amount of randomness of the generated unit cell.

In some embodiments, the system may include a processing module that is configured to generate a virtual 3D representation of the unit cell. The processing module may generate the virtual 3D representation of the unit cell based on data input by a user through a user interface. The input data may include design parameters for the unit cell. The processing module may include, for example, a central processing unit (CPU), a graphics processing unit (GPU), a microprocessor, a controller, a microcontroller, a digital signal processor (DSP), a field-programmable gate array (FPGA), an application-specific integrated circuit (ASIC), and/or another type of processing component. The processing module may be implemented in hardware, software, or a combination of hardware and software (e.g., firmware). In some embodiments, the processing module may include one or more processors capable of being programmed to perform one or more operations of the system.

In some embodiments, the system may include a validation module that assesses and validates a custom unit cell design. For example, a user may input data related to specified material properties, mechanical requirements, and/or geometric constraints of a lattice structure, and the validation module may assess the unit cell design to ensure compliance with the input data.

In some embodiments, the system may include a storage module for storing the designs of unit cells in a database for future use. The storage module may include volatile and/or nonvolatile memory. For example, the storage module may include random access memory (RAM), read only memory (ROM), a hard disk drive, and/or another type of memory (e.g., a flash memory, a magnetic memory, and/or an optical memory). The storage module may include internal memory (e.g., RAM, ROM, or a hard disk drive) and/or removable memory (e.g., removable via a universal serial bus (USB) connection). The storage module may include a non-transitory computer-readable medium storage device. In some embodiments, the storage module may utilize cloud-based storage services to store unit cell designs. In some embodiments, the storage module may be coupled to the processing module via, for example, a bus, thereby enabling a user to load a unit cell design from the storage module and generate a virtual 3D representation of the unit cell.

In some embodiments, the system may include an output module that generates design specifications for the unit cell in various file formats. A user may then populate a lattice structure based on the design specifications in a lattice-generation software (e.g., Carbon Design Engine™) and generate machine-readable instructions for 3D printing the lattice structure. The machine-readable instructions may include specifications for the arrangement and integration of the unit cells within the lattice structure.

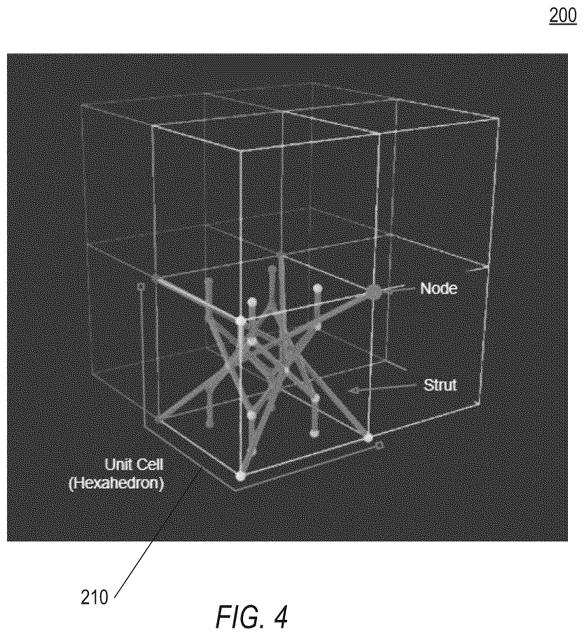

FIG. 4 is an example diagram 200 illustrating a custom unit cell 210, according to some embodiments of the present disclosure.

Referring to FIG. 4, the unit cell 210 may be a hexahedron or as a hexahedral volume, but the present disclosure is not limited thereto, and many polyhedrons may be used as the basis of the unit cell 210. The selection of the type of polyhedron for the unit cell 210 may impact various properties of a 3D printed object such as, for example, mechanical properties, material usage, printability, assembly, and performance requirements. For example, a unit cell based on a hexahedron (e.g., a cube) may provide substantially uniform mechanical properties in all directions, which may make it more suitable for applications requiring isotropy (i.e., uniformity). On the other hand, unit cells based on an irregular polyhedron may provide, for example, varying stiffness and strength along different axes of a 3D printed object. Some polyhedrons may result in more efficient material usage, which may minimize waste and may reduce the overall weight of a 3D printed object. The geometric complexity of a polyhedron can also impact the printability of a lattice structure as a 3D printed object. According to some embodiments of the present disclosure, the system for unit cell creation and visualization may enable a user to design the unit cell 210 as a specific polyhedron (e.g., a hexahedron in FIG. 4) to meet requirements and/or constraints related to, for example, mechanical properties, material usage, printability, assembly, and performance of a 3D printed object.

According to some embodiments of the present disclosure, the system for unit cell creation and visualization may enable a user to manipulate and adjust coordinates (e.g., nodes) to customize the design of the unit cell 210 according to specific requirements or constraints. Referring to FIGS. 3 and 4, the system may enable a user to issue one or more modification commands via a user interface 100 which may modify coordinates by moving the nodes in the virtual 3D representation of the unit cell or by inputting the coordinates into the formatting table 160. For example, the system may enable the user to modify the coordinates by moving the nodes in the virtual 3D representation of the unit cell through a drag and drop feature (e.g., provided by a GUI).

According to some embodiments of the present disclosure, the system for unit cell creation and visualization may allow a user to modify the arrangement, orientation, and/or thickness of the struts to meet the specific design requirements and desired mechanical properties of a lattice structure. The design of the struts may help determine, for example, the overall strength, stiffness, and performance of the lattice structure formed from the unit cells 210, which is then translated to a 3D printed object. The system for unit cell creation and visualization may enable a user to optimize the strut geometry and arrangement to achieve desired properties for the lattice structure.

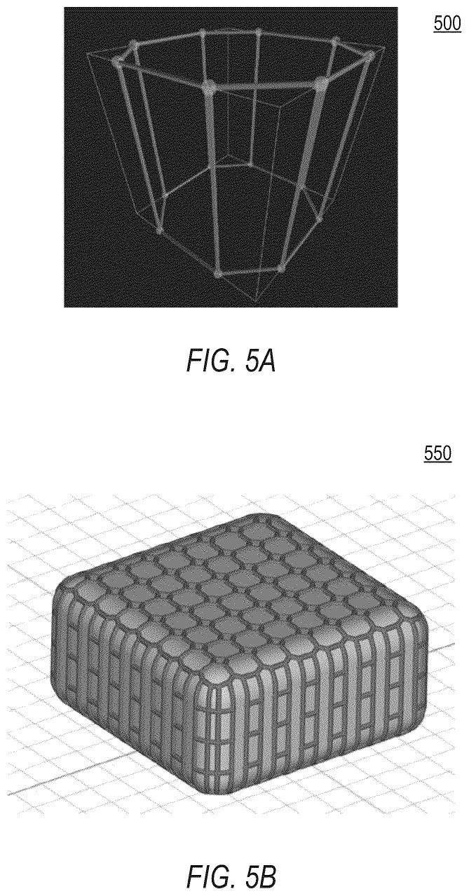

FIGS. 5A and 5B are example diagrams illustrating a custom unit cell 500 and a lattice 550 including the custom unit cell 500, respectively, according to some embodiments of the present disclosure.

Referring to FIG. 5A, the custom unit cell 500 may be built from scratch or modified by a user based on an existing unit cell design. Referring to FIG. 5B, the lattice 550 may be formed from a repeating structure of the custom unit cell 500. For example, once the custom unit cell design is finalized, the system for unit cell creation and visualization may enable a user to export design specifications for the unit cell 500 in various file formats. A user may then import the design specifications for the unit cell 500 into software configured to generate a lattice 550 based on the unit cell 500. In some embodiments, the exported design specifications may be compatible with 3D printing software and hardware, thus providing a transition from design of the unit cell 500 to fabrication of a 3D printed object. In other embodiments, a user may generate machine-readable instructions for 3D printing the lattice 550 structure from the lattice-generation software.

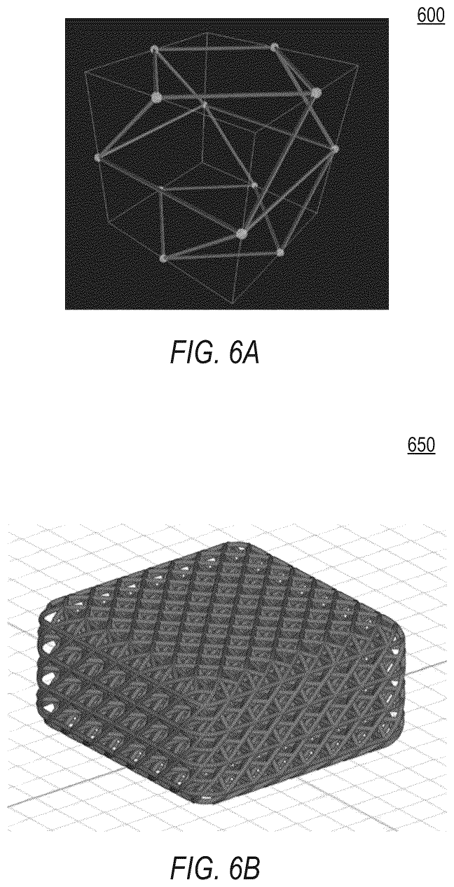

FIGS. 6A and 6B are example diagrams illustrating a custom unit cell 600 and a lattice 650 including the custom unit cell 600, respectively, according to some embodiments of the present disclosure.

Referring to FIG. 6A, the custom unit cell 600 may be built from scratch or modified by a user based on an existing unit cell design. Referring to FIG. 6B, the lattice 650 may be formed from a repeating structure of the custom unit cell 600.

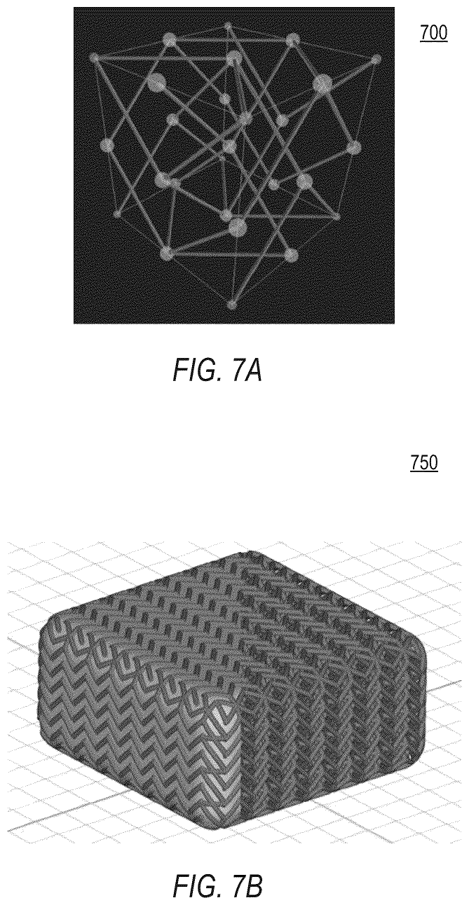

FIGS. 7A and 7B are example diagrams illustrating a custom unit cell 700 and a lattice 750 including the custom unit cell 700, respectively, according to some embodiments of the present disclosure.

Referring to FIG. 7A, the custom unit cell 700 may be built from scratch or modified by a user based on an existing unit cell design. Referring to FIG. 7B, the lattice 750 may be formed from a repeating structure of the custom unit cell 700.

Three-dimensional unit cells such as polyhedron unit cells have been described. In addition, in some embodiments, two-dimensional unit cells may be created, modified, and/or used to populate a lattice structure as described herein. For example, lattice-generation software (e.g., Carbon Design Engine™) may include the capability to create a lattice using two-dimensional unit cells defined by polygons (e.g., triangles).

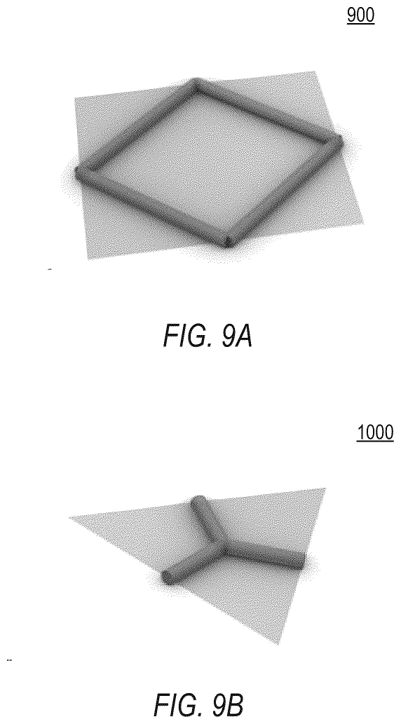

FIGS. 9A and 9B are example diagrams illustrating two-dimensional cell units according to some embodiments of the present disclosure. Referring to FIG. 9A, a unit cell 900 may be defined by a quadrilateral (e.g., rectangle or square). Referring to FIG. 9B, a unit cell 1000 may be defined by a triangle.

The two-dimensional unit cells, such as the unit cells 900 and 1000 of FIGS. 9A and 9B, may be “surface lattices” (e.g., define at least a portion of the outer or outermost surface of the lattice). The two-dimensional unit cells may map to the mesh (e.g., triangle mesh) itself, whereas the three-dimensional unit cells may map to a scaffold generated in a lattice-generation software (e.g., Carbon Design Engine™).

The two-dimensional unit cells, such as the unit cells 900 and 1000 of FIGS. 9A and 9B, may be used to generate objects such as, for example, textiles and textile-like structures, footwear uppers, bicycle saddles or seats, or sections thereof.

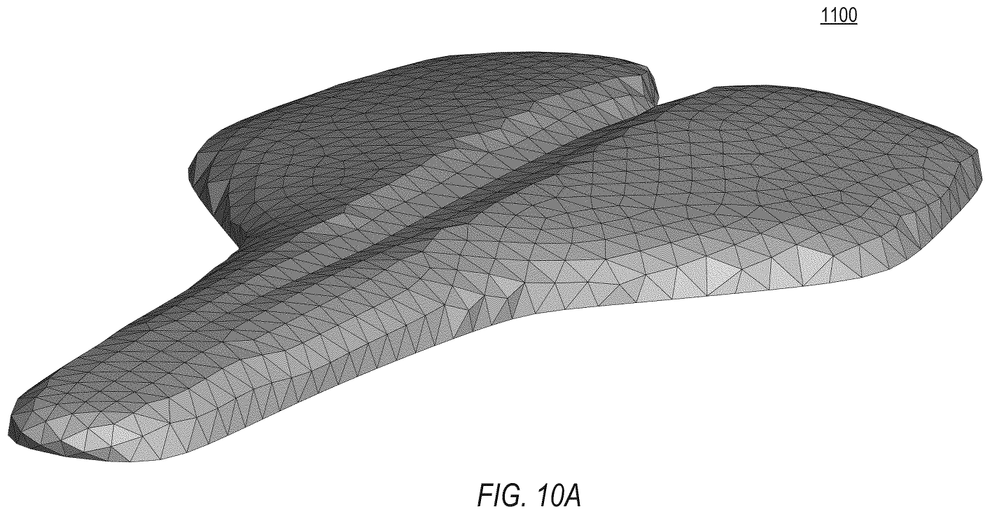

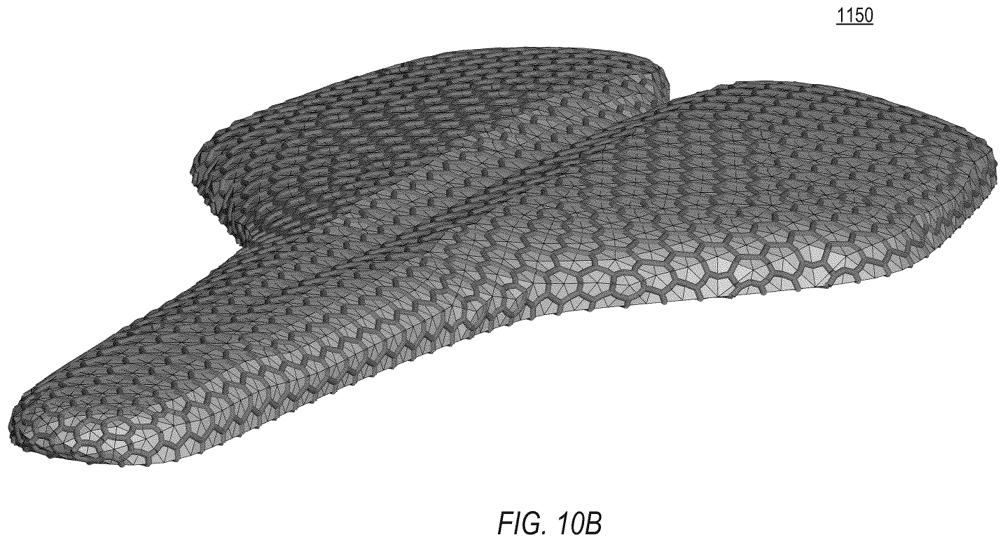

The generation of an example saddle comprising a lattice is illustrated in FIGS. 10A and 10B.

FIG. 10A illustrates a triangle mesh 1100 for the saddle. FIG. 10B illustrates populating the triangles of the triangle mesh 1100 with struts, and each populated triangle may be considered a unit cell. The populated unit cells form a lattice 1150. In the illustrated example, the lattice 1150 includes a plurality of hexagons. However, the lattice 1150 may additionally or alternatively include other shapes such as, for example, alternative polygons or rhombuses.

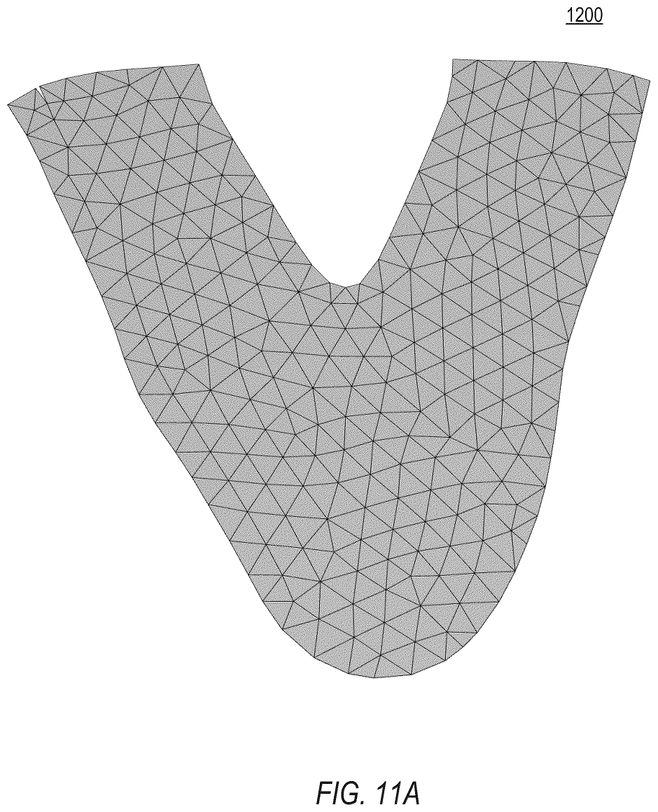

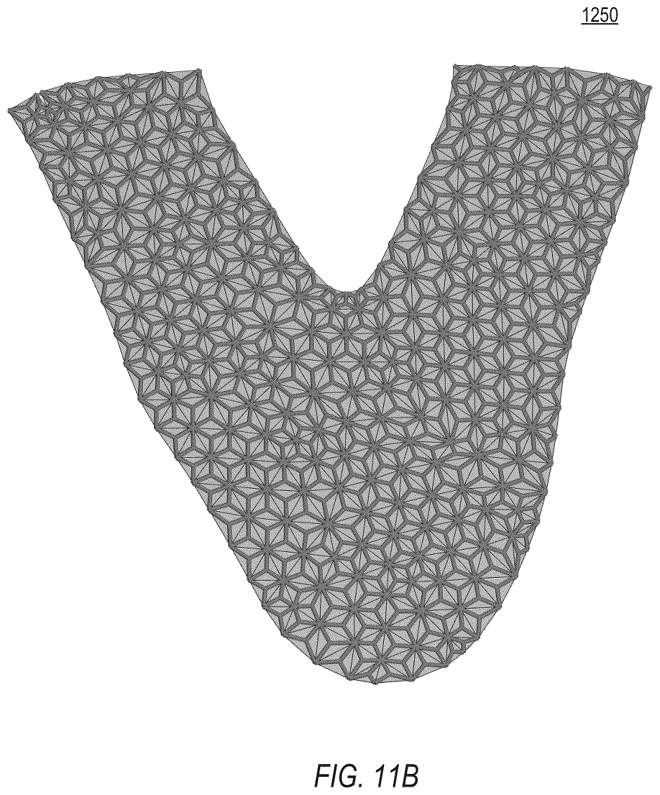

The generation of an example footwear upper comprising a lattice is illustrated in FIGS. 11A and 11B.

FIG. 11A illustrates a triangle mesh 1200 for the upper. FIG. 11B illustrates populating the triangles of the triangle mesh 1200 with struts, and each populated triangle may be considered a unit cell. The populated unit cells form a lattice 1250. In the illustrated example, the lattice 1250 includes a plurality of rhombuses. However, the lattice 1250 may additionally or alternatively include other shapes such as, for example, polygons (e.g., hexagons).

As noted above, the two-dimensional unit cells may be used for a “surface lattice,” which may be the outer surface of a three-dimensional object, with three-dimensional unit cells as described herein used for a “volumetric lattice” of the three-dimensional object. In some other embodiments, the two-dimensional unit cells may be used to generate a flat or substantially flat object, such as for the lattice 1250 shown in FIG. 11B.

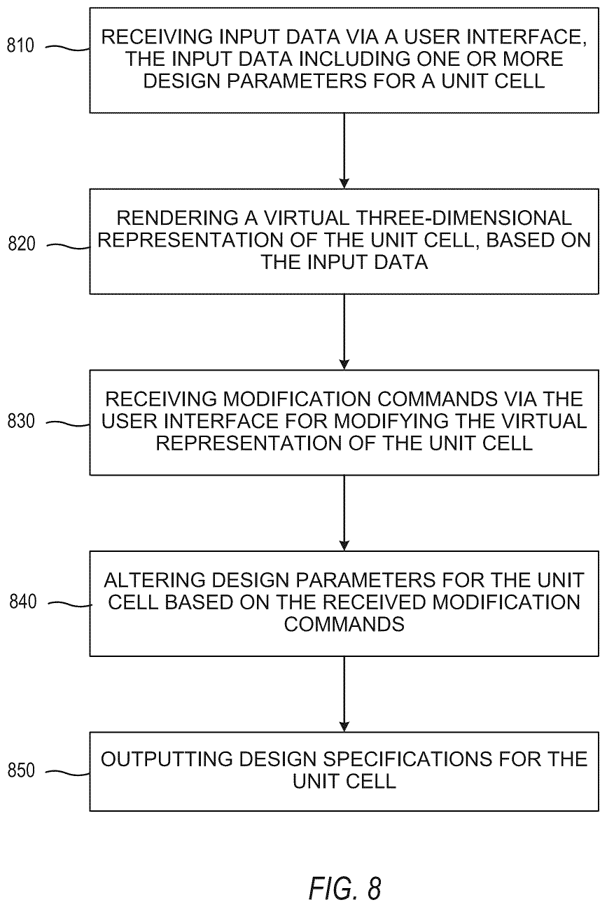

FIG. 8 is an example flowchart illustrating a method for designing a unit cell, according to some embodiments of the present disclosure.

Referring to FIG. 8, the method for designing a unit cell may include receiving input data via a user interface, and the input data may include one or more design parameters for a unit cell (step 810). For example, the one or more design parameters may include geometric properties of the unit cell.

The method may further include rendering a virtual three-dimensional representation of the unit cell, based on the input data (step 820). The virtual three-dimensional representation of the unit cell may include struts. For example, the virtual representation of the unit cell may be a polyhedral shape including the struts. The user interface may display the virtual three-dimensional representation of the unit cell within a window or portion thereof. In some embodiments, the user interface may also display a formatting table that includes numerical data related to the virtual three-dimensional representation of the unit cell.

The method may further include receiving, e.g., from selectable tools within the user interface, modification commands for modifying the virtual three-dimensional representation of the unit cell (step 830). For example, the selectable tools within the user interface may enable a user to modify the geometric properties of the unit cell. For example, the selectable tools within the user interface may enable a user to subdivide the unit cell, add a strut or node to the unit cell, move a strut or node within the unit cell, and/or delete a strut or node (and struts connected thereto) from the unit cell. The selectable tools within the user interface may enable a user to modify the polyhedral shape of the unit cell and struts included in the unit cell. In some embodiments, the user interface may include a GUI, and the tools for modifying the virtual three-dimensional representation of the unit cell may be provided within the GUI.

The method may further include altering design parameters for the unit cell based on the received modification commands (step 840). For example, in response to receiving one or more of the modification commands, the system may modify data (e.g., array data, tabular data, matrix data) stored in a memory and corresponding to the unit cell visualized in the user interface portion 110 (e.g., see FIG. 3).

The method may further include outputting design specifications for the unit cell (step 850). For example, the design specifications for the unit cell may be compatible with software for generating a lattice structure based on the unit cell.

In some embodiments, the method may include forming a lattice structure, based on the design specifications for the unit cell. For example, the lattice structure may be formed for 3D printing applications.

Example embodiments of the present disclosure may provide methods and systems for unit cell creation and visualization that enable users to easily customize and visualize unit cells in real-time, thereby facilitating the rapid prototyping and production of customized 3D printed objects tailored to each user's needs. Accordingly, example embodiments of the present disclosure may provide various benefits for unit cell creation and visualization, particularly in the field of additive manufacturing.

Unless otherwise defined, all terms used herein have the same meaning as commonly understood by one of ordinary skill in the art. Further, all terms should be interpreted as having a meaning that is consistent with their meaning in the context of the relevant art and the present disclosure and will not be interpreted in an idealized or overly formal sense unless expressly so defined herein.

The terminology used herein is for the purpose of describing particular embodiments only and is not intended to be limiting of embodiments. The singular forms “a”, “an”, and “the” are intended to include the plural forms as well, unless the context clearly indicates otherwise. The terms “comprises”, “comprising”, “includes”, “including”, “has”, “having” and any other variations thereof specify the presence of the stated features, steps, operations, elements, components and/or groups, but do not preclude the presence or addition of one or more other features, steps, operations, elements, components and/or groups thereof.

Example embodiments may be described herein with reference to the accompanying drawings. Many different forms and embodiments are possible without deviating from the teachings of the present disclosure. Accordingly, the present disclosure should not be construed as limited to the example embodiments set forth herein. As such, it will be understood by those of ordinary skill in the art that various changes in form and details may be made therein without departing from the scope of the present disclosure. The present specification, including the drawings, shall be construed to constitute a complete written description of all combinations and subcombinations of the embodiments described herein, and of the manner and process of making and using them, and shall support claims to any such combination or subcombination.

The example embodiments are mainly described in terms of particular methods and devices provided in particular implementations. However, the methods and devices may operate effectively in other implementations. Phrases such as “example embodiment”, “one embodiment”, “embodiment” and “another embodiment” may refer to the same or different embodiments as well as to multiple embodiments. The embodiments are described with respect to systems and/or devices having certain components. However, the systems and/or devices may include fewer or additional components than those shown, and variations in the arrangement and type of the components may be made without departing from the scope of the present disclosure.

The example embodiments are also described in the context of particular methods having certain steps or operations. However, the methods and devices may operate effectively for other methods having different and/or additional steps/operations and steps/operations in different orders that are not inconsistent with the example embodiments. Thus, the present disclosure is not intended to be limited to the embodiments shown, but is to be accorded the widest scope consistent with the principles and features described herein.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but is not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Aspects of the present disclosure may be described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. As used herein, “a processor” may refer to one or more processors.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Although some of the diagrams include arrows on communication paths to show a primary direction of communication, it is to be understood that communication may occur in the opposite direction to the depicted arrows. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Computer program code for carrying out operations for aspects of the present disclosure may be written in any combination of one or more programming languages, including an object oriented programming language such as Java, JavaScript, Scala, Smalltalk, Eiffel, JADE, Emerald, C++, C#, VB.NET, JSON, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

The foregoing is illustrative of the present invention, and is not to be construed as limiting thereof. The invention is defined by the following claims, with equivalents of the claims to be included therein.

1. A method for designing a unit cell, the method comprising:
receiving input data via a user interface, the input data comprising one or more input design parameters for the unit cell;
rendering a virtual three-dimensional (3D) representation of the unit cell within the user interface, based on the input design parameters;
receiving, via the user interface, at least one modification command modifying the virtual 3D representation of the unit cell;
altering the input data based on the received at least one modification command, resulting in modified design parameters for the unit cell differing from the input design parameters; and
outputting the modified design parameters for the unit cell.

2. The method of claim 1, wherein the virtual 3D representation of the unit cell comprises a plurality of struts, and
wherein at least one first selectable tool is provided within the user interface to enable a user to modify the plurality of struts.

3. The method of claim 2, wherein the at least one first selectable tool enables the user to add a strut to the virtual 3D representation of the unit cell and/or remove a strut from the virtual 3D representation of the unit cell.

4. The method of claim 2, wherein the virtual 3D representation of the unit cell is a polyhedral shape comprising the plurality of struts, and
wherein at least one second selectable tool is provided within the user interface to enable the user to modify the polyhedral shape.

5. The method of claim 1, wherein rendering the virtual 3D representation of the unit cell comprises generating instructions to display the virtual 3D representation of the unit cell within a first portion of a graphical user interface (GUI) window of the user interface.

6. The method of claim 5, further comprising generating instructions to display, within a second portion of the GUI window of the user interface, a formatting table that comprises numerical data related to the virtual 3D representation of the unit cell.

7. The method of claim 1, wherein outputting the modified design parameters for the unit cell comprises outputting the modified design parameters in a format that is compatible with software configured to generate a lattice structure based on the unit cell having the modified design parameters.

8. The method of claim 1, wherein at least one selectable tool is provided within the user interface to enable a user to subdivide the virtual 3D representation of the unit cell.

9. The method of claim 1, wherein the unit cell is a first unit cell,
wherein at least one selectable tool is provided within the user interface to enable a user to generate a random or semi-random virtual 3D representation of a second unit cell, and
wherein the method further comprises rendering the random or semi-random virtual 3D representation of the second unit cell within the user interface.

10. The method of claim 9, wherein the at least one selectable tool enables the user to predefine a number of struts and a number of nodes included in the random or semi-random virtual 3D representation of the second unit cell.

11. The method of claim 1, further comprising forming a lattice structure for three-dimensional (3D) printing, based on the modified design parameters for the unit cell.

12. A system for designing a unit cell, the system comprising:
at least one processor; and
memory storing non-transitory computer-readable instructions that, when executed by the at least one processor, cause the at least one processor to perform operations comprising:
receive, as a first input via a user interface, input data comprising one or more input design parameters for the unit cell;
render, based on the input data, a virtual three-dimensional (3D) representation of the unit cell;
receive, as a second input via the user interface, a modification command indicating a requested modification to the virtual 3D representation of the unit cell;
alter, based on the received modification command and the requested modification, the input design parameters for the unit cell, resulting in modified design parameters; and
output the modified design parameters for the unit cell.

13. The system of claim 12, wherein the modified design parameters for the unit cell are output in a format that is compatible with software configured to generate a lattice structure based on the unit cell having the modified design parameters.

14. The system of claim 12, wherein the one or more input design parameters comprise first geometric properties for the unit cell, and
wherein the modified design parameters comprise second geometric properties for the unit cell, the second geometric properties being different from the first geometric properties.

15. The system of claim 12, wherein the virtual 3D representation of the unit cell comprises a plurality of nodes and a plurality of struts connecting corresponding pairs of the plurality of nodes.

16. The system of claim 12, wherein the virtual 3D representation of the unit cell is rendered within a first portion of the user interface.

17. A method for designing a unit cell, the method comprising:
receiving input data via a user interface, the input data comprising one or more design parameters for the unit cell;
rendering, within the user interface, a virtual three-dimensional (3D) representation of the unit cell; and
outputting design specifications for the unit cell.

18. The method of claim 17, wherein outputting the design specifications for the unit cell comprises outputting the design specifications for the unit cell in a format that is compatible with software configured to generate a lattice structure based on the unit cell.

19. The method of claim 17, wherein the one or more design parameters comprise geometric properties of the unit cell, and
wherein at least one selectable tool is provided within the user interface to enable a user to modify the geometric properties of the unit cell.

20. The method of claim 17, wherein at least one selectable tool is provided within the user interface to enable a user to subdivide the virtual 3D representation of the unit cell, add a strut to the virtual 3D representation of the unit cell, and delete a strut from the virtual 3D representation of the unit cell.
